(19) United States
(12) Patent Application Publication
(10) Pub. No.: US 2011/0162639 A1
(43) Pub. Date: Jul. 7, 2011

(54) SUPPORT DEVICE FOR SUPPORTING SOLAR ENERGY RECOVERY MODULES, A SOLAR ENERGY RECOVERY UNIT AND A METHOD OF MOUNTING SOLAR ENERGY RECOVERY MODULES

(76) Inventor: Jean-Claude Jeandeaud, Saint Marcel Bel Accueil (FR)

(21) Appl. No.: 12/994,713

(22) PCT Filed: May 27, 2009
(86) PCT No.: PCT/FR09/50981

§ 371 Date: Mar. 14, 2011

(30) Foreign Application Priority Data
May 27, 2008 (FR) 08 53431

(51) Int. Cl. F24J 2/46; F24J 2/52; F24J 2/04; B21D 53/02; B23P 11/00

(52) U.S. Cl. 126/634; 126/704; 29/890.033; 29/428

(57) ABSTRACT

The invention relates to a mounting device (3) for at least one module (400) for recovering power from solar radiation that includes a first (54) and second (56) groove arranged in a stationary manner opposite one another. Each groove (54, 56) is capable of receiving a module edge (402A, 402B) while an opposite module edge (402B, 402A) is received in the other groove. In the configuration for maximum sinking of an edge (402A, 402B) of the module (400) into a groove (54, 56) from among the two grooves, the opposite module edge (402B, 402A) is capable of being extracted from the other edge, and the device contains a means (9) for maintaining the module in a position wherein the two opposite module edges (402A, 402 B) are received in the first (54) and second (56) groove, respectively. The grooves (54, 56) are formed in a section (5) making it possible to completely hold up each module (400).

The present invention relates to a support device for supporting at least one energy recovery module for recovering energy from solar radiation, and to an energy recovery unit for recovering energy from solar radiation. The invention also relates to an air removal system for removing air from an energy recovery unit for recovering energy from solar radiation, and to a method of mounting at least one energy recovery module for recovering energy from solar radiation on a structure, such as a roof or a façade of a building or indeed a free-standing structure.

In the meaning of the invention, an energy recovery module for recovering energy from solar radiation is either a photovoltaic solar module suitable for converting energy from solar radiation into electrical energy, or a thermal solar module suitable for converting energy from solar radiation into thermal energy recovered in a heat transfer fluid, or a combination of a photovoltaic solar module and of a thermal solar module.

In known manner, a photovoltaic solar module is in the form of a panel made up of a plurality of photovoltaic cells interposed between a transparent front plate, e.g. made of glass or of a plastics material and designed to be exposed to solar radiation, and a back plate that is transparent or opaque, e.g. made of glass or of Tedlar (registered trademark), and that is designed to be arranged facing a structure for mounting the module. Such a photovoltaic module is conventionally manufactured individually, and assembled with other modules while it is being mounted on a structure, such as a roof or a façade of a building. To this end, it is known that a photovoltaic module can be equipped with a metal frame that covers the outside peripheral edge of the module. The module is then fastened to a mounting structure by securing the frame to the structure, when the module is mounted individually, and/or to the frame of another module when a plurality of juxtaposed modules are mounted. Once fastened to the structure, each module must also be connected electrically, via connection cables, to means for making available the electrical current generated by the module with a view to it being used by suitable appliances or other suitable systems.

Securing the frame of each module to the mounting structure, and possibly to the frames of the adjacent modules, and managing the electrical wiring for each module, requires work by operators who are qualified for installing photovoltaic modules on a structure. Since the modules are manufactured by means of plates of glass or of other rigid materials, the modules must be handled with care, in particular during transport and installation of the modules, in order to avoid damaging the modules in any way. In addition, when one or more photovoltaic modules are mounted in such manner as to be integrated into a roof, it is necessary to install a structure for receiving the modules, in particular by means of battens and of beams, in addition to the initial structure of the roof, thereby increasing the time and the cost of installing the modules. In particular, it is necessary to provide a host structure for receiving the modules that is sufficiently dense to impart sufficient strength to the roof incorporating the photovoltaic modules. Individually mounting modules thus requires the host structure to have an inter-member pitch that is equal to the dimensions of each module. Juxtaposed mounting of modules with the frames of adjacent modules being secured together makes it possible for the host structure to have an inter-member pitch that is larger, but does not allow the modules to be replaced in the event of failure.

Analogous problems arise with thermal solar modules.

In addition, it is known from JP-A-2004 116240 that crosspieces can be mounted on the roof of a building in a horizontal direction, and the top and bottom of the edges of solar panels can then be inserted into ribs provided in said crosspieces. The crosspieces must be positioned accurately on the roof, in order to receive the edges of the panels in a configuration in which said panels are secured effectively in order to withstand the weather. In particular, the crosspieces must be exactly parallel, otherwise a panel in a row of panels might not be able to be installed between two crosspieces, or, conversely, might not be held effectively.

More particularly, an object of the invention is to remedy those drawbacks by proposing a support device for supporting energy recovery modules for recovering energy from solar radiation that makes it easier to mount such modules on a host structure, with limited cost, and without any risk of damaging the modules, this support device also making to possible to replace the modules individually, once they have been mounted, in the event of failure.

To this end, the invention provides a support device for supporting at least one energy recovery module for recovering energy from solar radiation, the support device being of the type provided with a first groove and with a second groove that are arranged in stationary manner facing each other, each groove being suitable for receiving one edge of the module while an opposite edge of the module is received in the other groove, in which device, in the configuration in which one edge of the module is engaged to the maximum extent in one of the first and second grooves, the opposite edge can be extracted from the other groove, while the device is provided with holding means for holding the module in a configuration in which the two opposite edges of the module are received respectively in the first groove and in the second groove. According to the invention, the device comprises a section member that is provided with the first and second ribs.

By means of the invention, it is possible to form a physical entity made up of a section member and of one or more energy recovery modules, it being possible for said physical entity to be brought to the site of implementation, and installed on the site in particularly simple manner. A section member provided with grooves may be equipped, in the workshop, with one or more energy recovery modules, in order to constitute a ready-to-install sub-assembly, which is particularly advantageous in terms of ease of installation and reduces the amount of time required for the work. In addition, the web of such a section member makes it possible to perform a weatherproofing function, by weatherproofing the roof against runoff water, which is not possible with the separate beams of JP-A-2004 116240. In addition, the invention facilitates incorporation of any thermally-insulating and soundproofing layer, thereby making it possible to constitute an integrated and ready-to-install sub-assembly forming an insulated energy recovery unit for recovering energy from solar radiation.

According to other advantageous characteristics of a support device of the invention, taken in isolation or in any technically feasible combination, the device may incorporate the characteristics of any one of claims 2 to 16.

The invention also provides an energy recovery unit for recovering energy from solar radiation, the unit being of the type comprising a support device as described above and at least one energy recovery module for recovering energy from solar radiation, said module(s) being mounted on the support device.

The invention also provides an air removal system for removing air from at least one energy recovery unit for recovering energy from solar radiation as described above, said system comprising ducts for removing hot air contained in a volume, defined between a web of the section member and the module of the unit, either towards the outside or towards means for using said hot air.

In addition, the invention also provides a method of mounting at least one energy recovery module for recovering energy from solar radiation on a structure, such as a roof or a façade of a building or indeed a free-standing structure, by means of a support device as defined above, the method comprising steps consisting in:
pre-mounting the or each module on the section member of the support device by performing at least the following operations:
   engaging one edge of the module to the maximum extent in one of the first and second grooves in the section member;
   pivoting the module in such a manner as to bring the opposite edge of the module to face the other of the first and second grooves in the section member;
   engaging the opposite edge of the module in the other groove in the section member, by moving the module in translation;
   holding the module stationary relative to the support device in a position in which the two opposite edges of the module are received respectively in the first groove and in the second groove; and
fastening the support device to the structure.

The invention also provides a support device for supporting at least one energy recovery module for recovering energy from solar radiation, the support device comprising a section member on which the module is suitable for being mounted, which section member is provided with at least one reinforcing rib, the or each reinforcing rib being suitable for supporting one face of the module, in the configuration in which the module is mounted in the section member.

Finally, the invention provides a support device for supporting at least one energy recovery module for recovering energy from solar radiation, the support device comprising a section member on which the module is suitable for being mounted and at least one pipe through which a heat transfer fluid can flow, said pipe being arranged in an air flow volume that is defined between a web of the section member and the module, in the configuration in which the module is mounted on the section member.

The characteristics and advantages of the invention appear in the following description of embodiments of an energy recovery unit and of a method of mounting of the invention, given merely by way of example and with reference to the accompanying drawings, in which:

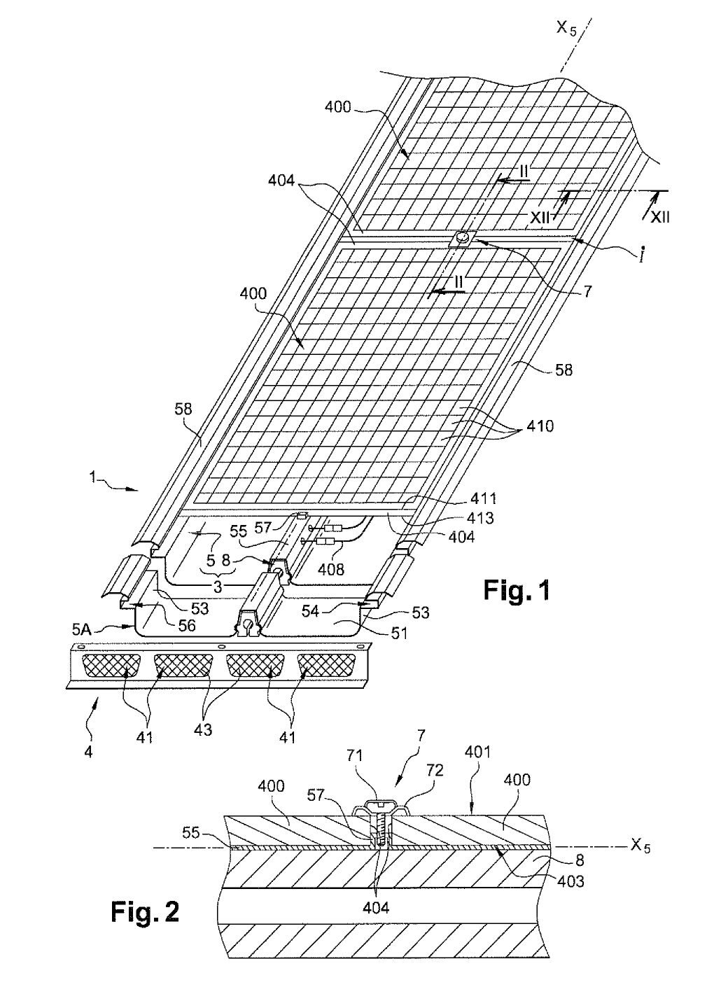

FIG. 1 is a fragmentary perspective view of a first embodiment of an energy recovery unit of the invention, comprising a first embodiment of a support device and at least two energy recovery modules for recovering energy from solar radiation;

FIG. 2 is a fragmentary section view on line II-II in FIG. 1;

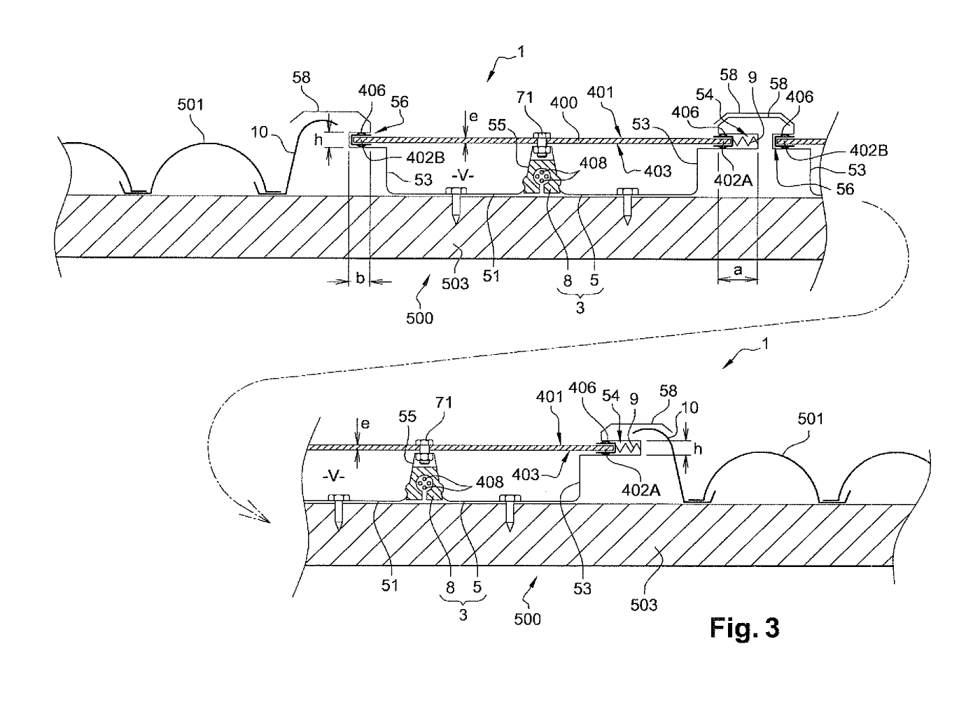

FIG. 3 is a cross-section view through two energy recovery units identical to the unit of FIG. 1 that are mounted in juxtaposed manner on the roof of a building;

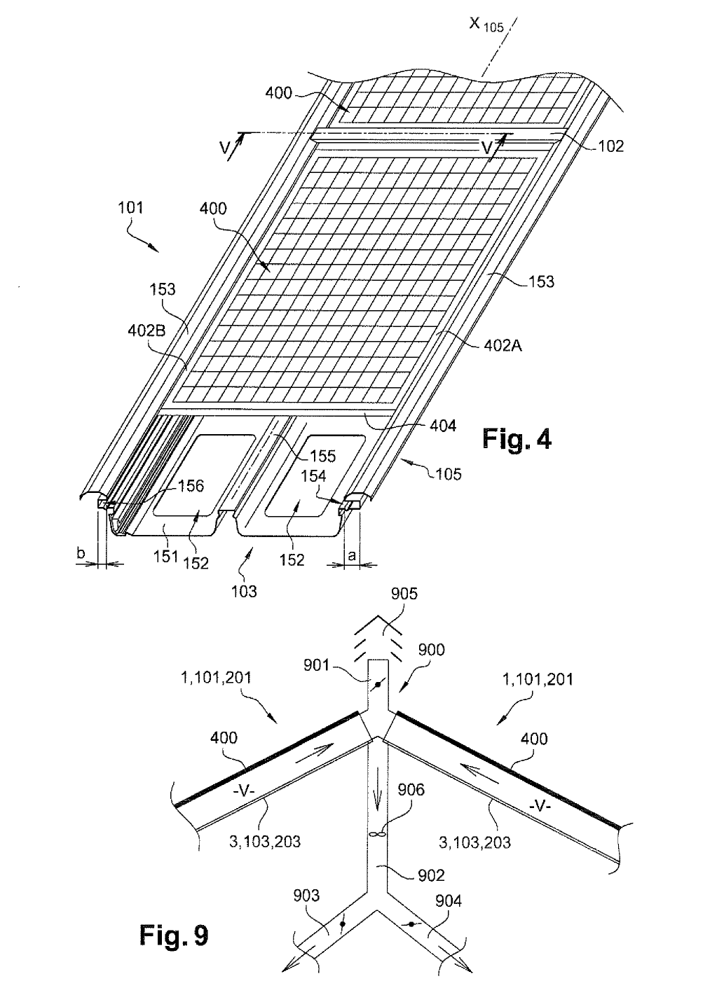

FIG. 4 is a view analogous to FIG. 1 for a second embodiment of an energy recovery unit of the invention, comprising a second embodiment of a support device and at least two energy recovery modules for recovering energy from solar radiation;

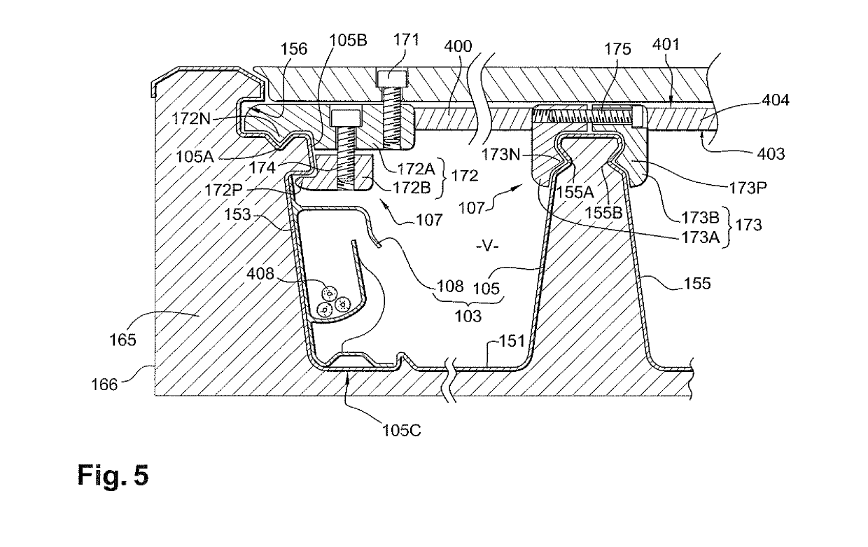

FIG. 5 is a fragmentary section view on line V-V in FIG. 4;

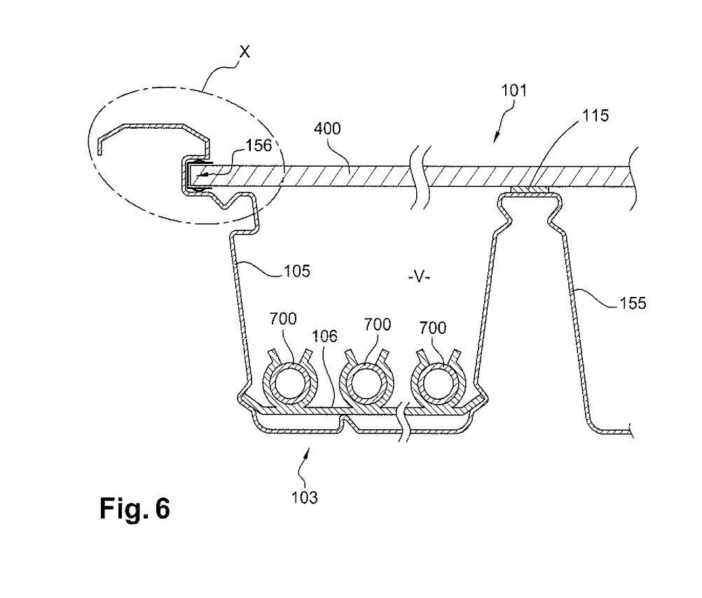

FIG. 6 is a view analogous to the FIG. 5 view, showing a variant of the energy recovery unit of FIG. 4;

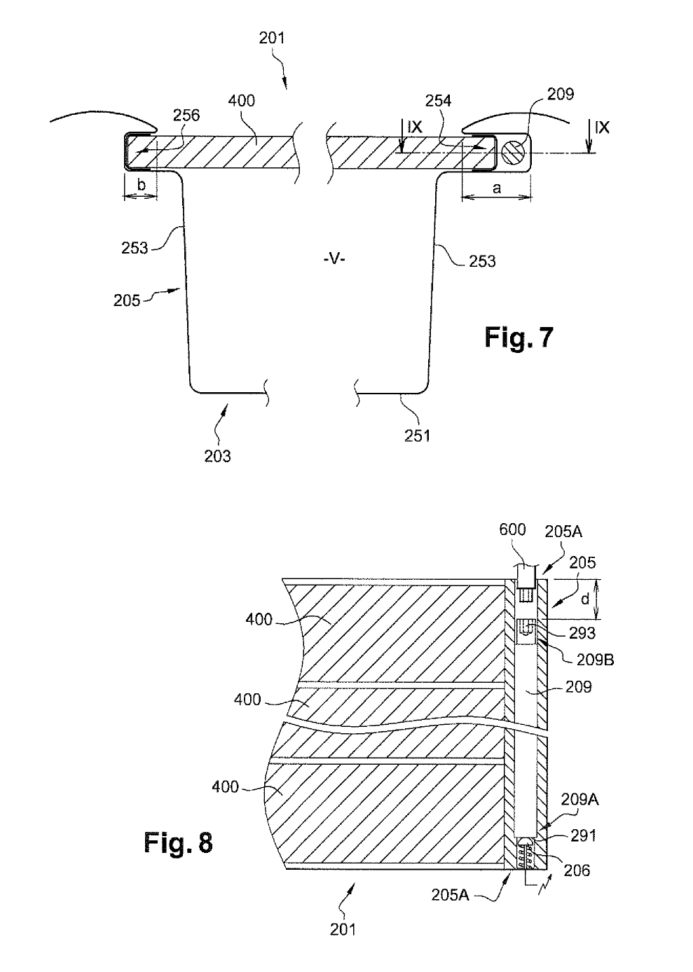

FIG. 7 is a view analogous to FIG. 3 for a third embodiment of an energy recovery unit of the invention, including a third embodiment of a support device;

FIG. 8 is a fragmentary section view on line VIII-VIII in FIG. 7, showing a plurality of energy recovery modules for recovering energy from solar radiation mounted on the support device of FIG. 7;

FIG. 9 is a diagrammatic view of an air removal system associated with a set of energy recovery units as shown in any one of FIG. 1, 4, 6, or 7;

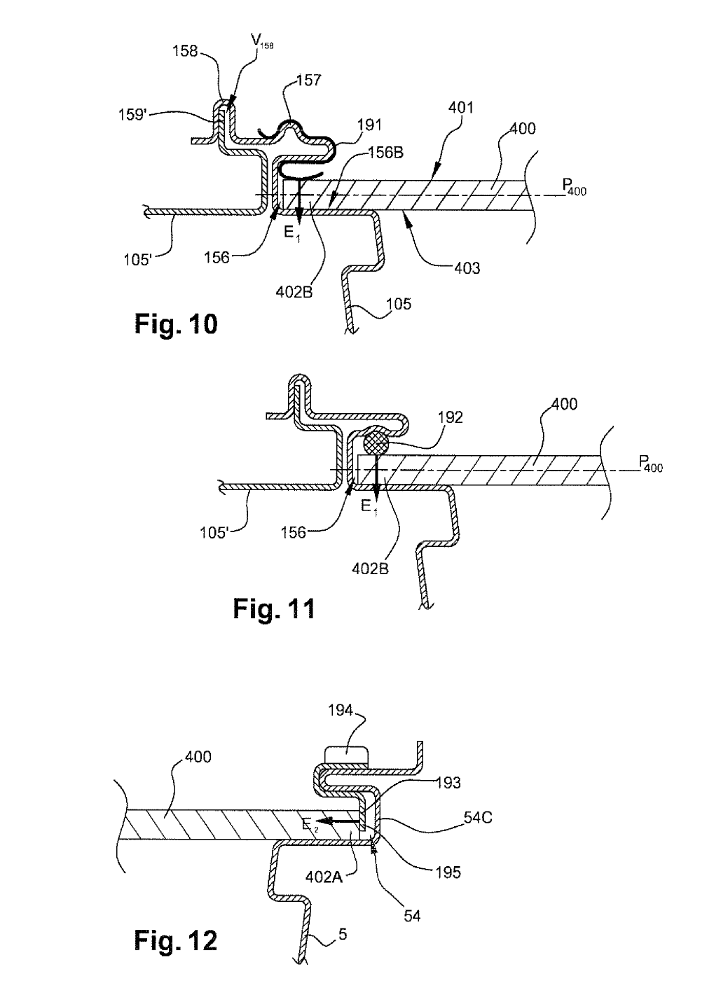

FIG. 10 is a view corresponding to the detail X in FIG. 6 for a fourth embodiment of a support device of the invention, when two supports are mounted side-by-side;

FIG. 11 is a view analogous to the FIG. 10 view, for a fifth embodiment of a support device; and

FIG. 12 is a detail view on line XII-XII in FIG. 1, for a sixth embodiment of a device of the invention.

The energy recovery unit 1 for recovering energy from solar radiation that is shown in FIG. 1 is designed to be mounted on a structure, such as a roof or a façade of a building, or indeed a free-standing structure. The unit 1 comprises a plurality of energy recovery modules 400 for recovering energy from solar radiation that, in this example, are photovoltaic modules, two of which are shown in FIG. 1. The unit 1 further comprises a support device 3 for supporting said modules 400. In known manner, each photovoltaic module 400 comprises a plurality of photovoltaic cells 410 interposed between two transparent plates, namely a front plate 411 and a back plate 413, that are, for example, made of glass. Each photovoltaic module 400 is equipped with connection cables 408 that are suitable for electrically connecting the module to means (not shown) for making available the electrical current generated by the modules of the unit 1, so that it can be used by suitable appliances.

The support device 3 for supporting the unit 1 comprises a section member 5 suitable for receiving photovoltaic modules 400, and an element 8 for guiding the connection cables 408 of modules 400 mounted on the section member 5. The section member 5 is of elongate shape, of the cladding or “box profile” type that has a web 51 and two side flanges 53. A longitudinal axis of the section member 5 is referenced X₅. The section member 5 is made from a metal blank that is shaped by continuous forming. Each side flange 53 of the section member 5 is shaped, preferably by forming, in such a manner as to define a groove 54 or 56 that is open towards the other side flange 53 of the section member 5, i.e. towards the inside of the section member 5, the grooves 54 and 56 being arranged facing each other. An end portion 58 of each side flange 53 is folded over towards the outside of the section member 5, in such a manner as to form a longitudinal margin of the section member 5 suitable for co-operating by overlapping with a corresponding margin 58 of an analogous and adjacent section member 5, as shown in FIG. 3. In addition, the web 51 of the section member 5 is provided with a central and longitudinal reinforcing rib 55 that projects towards the inside of the section member 5.

As can be seen more particularly in FIG. 3, the groove 54 in the section member 5 is designed to have a depth a that is greater than the depth b of the groove 56. In addition, each groove 54 or 56 has dimensions adapted to receive a longitudinal edge 402A or 402B of a module 400 equipped with a seal 406. More precisely, in this embodiment, each groove 54 or 56 has a height h greater than the thickness e of each module 400. In any event, the height h of each groove 54 or 56 is appropriate to the thickness of the corresponding edge of each module 400. Due to the grooves 54 and 56 being positioned facing each other, each groove 54 or 56 is suitable for receiving a respective longitudinal edge 402A or 402B of a photovoltaic module 400, while the opposite longitudinal edge 402A or 402B is received in the other groove. In addition, by means of the relative depths of the grooves 54 and 56, it is possible, in the configuration in which one longitudinal edge 402A of a module 400 is engaged to the maximum extent into the groove 54, to insert or to extract the opposite longitudinal edge 402B of the module relative to the groove 56. The support device 3 thus makes it easy to install and to remove a module 400 relative to the section member 5. Each module 400 is suitable for being held stationary relative to the section member 5, by fastening by means of screws, in a configuration in which the two opposite longitudinal edges 402A and 402B of the module are received respectively in the groove 54 and in the groove 56.

As clearly visible in FIG. 3, in the configuration in which a module 400 is mounted on the section member 5, in which configuration the two opposite longitudinal edges 402A and 402B of the module are received respectively in the groove 54 and in the groove 56, the reinforcing rib 55 is suitable for supporting the back face 403 of the module 400 via a pad 15 interposed between the top of the reinforcing rib 55 and the face 403 of the module. The module 400 is thus supported by the section member 5 not only at its longitudinal edges 402A and 402B, but also at a middle portion of the module, by interaction between the back face 403 of the module and the pad 15 arranged on the reinforcing rib 55. In a variant, the pad 15 may be replaced with a projecting piece in relief provided on the top of the reinforcing rib 55. The reinforcing rib 55 is also equipped with projections 57 designed to separate the two modules 400 and to hold them stationary relative to each other when they are mounted on the section member 5 in mutual alignment and parallel to the longitudinal axis X₅ of the section member 5.

Each module 400 mounted on the section member 5 is fastened relative to the section member 5 by fastening by means of screws in the vicinities of the two transverse edges 404 of the module. More precisely, as can be seen in FIG. 2, the support device 3 is provided with screw-fastening means 7 for fastening the modules 400 to the section member 5, which screw-fastening means comprise a self-tapping screw 71 designed to co-operate with a projection 57 on the reinforcing rib 55 between two adjacent modules 400, and a plate 72 for holding said two adjacent modules 400, interposed between the front faces 401 of the two modules 400 and the head of the screw 71.

In this embodiment, a spring 9 is arranged in the groove 54 that is of greater depth, so as to urge each module 400 resiliently to bear against the end wall of the groove 56 after said module has been inserted into the two grooves 54 and 56. The spring 9 is fastened either to the end wall of the groove 54, or to the longitudinal edge 402A of the module 400. The spring 9 guarantees that the module 400 is pre-positioned in a configuration in which the two opposite longitudinal edges 402A and 402B of the module 400 are received respectively in the groove 54 and in the groove 56, the module then being held stationary in said configuration by screw-fastening by means of the fastening means 7.

In the configuration in which the modules 400 are mounted on the section member 5, in which configuration, the two opposite longitudinal edges 402A and 402B of each module 400 are received respectively in the groove 54 and in the groove 56, a volume V through which air can flow is defined between the web 51 of the section member 5 and the module 400. The air-flow volume V makes it possible to maintain the modules 400 at a temperature that is satisfactory for them to operate. In particular, the flow of air through the volume V prevents any rise in temperature of the module 400 that might give rise to a reduction in the efficiency and in the longevity of the module. At each of its ends, one of which is shown in FIG. 1 at reference 5A, the section member 5 is suitable for being equipped with an end plate 4 provided with air flow orifices 41. Each of the orifices 41 is provided with netting 43 for limiting the extent to which interfering elements, such as leaves or animals, can pass into the volume V.

The guide element 8 belonging to the support device 3 is arranged in the volume defined by the reinforcing rib 55 on the outside of the section member 5. Advantageously, the guide element 8 is made of a synthetic material and is provided with pieces in relief that are projecting or that are recessed, and that are suitable for co-operating by snap-fastening with complementary recessed or projecting pieces in relief on the reinforcing rib 55

FIG. 3 shows how photovoltaic modules 400 can be mounted on the roof 500 of a building by means of the support device 3. As shown in FIG. 3, two support devices 3, on which respective ones of two series of photovoltaic modules 400 are mounted, are installed on the roof 500 of the building in such a manner as to be integrated into said roof. To this end, certain tiles 501 of the roof 500 have been removed at the desired mounting location at which the modules 400 are to be mounted, so that the support devices 3 are suitable for being fastened to the battens 503 of the roof 500, by fastening the webs 51 of the section members 5 to the battens 503 by screws. The adjacent section members 5 are fitted together via their longitudinal overlap margins 58, side section members 10 forming joins between the longitudinal margins 58 of the section members 5 and the adjacent tiles 501.

A method of mounting photovoltaic modules 400 on the roof 500 of a building by means of support devices 3 of the invention comprises steps in which:

Firstly, a plurality of photovoltaic units 1 are formed, by assembling together photovoltaic modules 400 and support devices 3. To this end, each photovoltaic module 400 is pre-mounted on the section member 5 of the support device 3, by engaging a longitudinal edge 402A of the module to the maximum extent into the groove 54, and then by pivoting the module 400 in a manner such as to bring the opposite longitudinal edge 402B of the module to face the groove 56. The spring 9 then urges the module 400 resiliently to cause said module to move in translation towards a configuration in which the longitudinal edge 402B is inserted in the groove 56, the two opposite longitudinal edges 402A and 402B of the module thus being received respectively in the groove 54 and in the groove 56. More precisely, the longitudinal edge 402B that is received in the groove 56 is held resiliently in abutment against the end wall of the groove 56 by the spring 9.

The module 400 is then held stationary in this configuration, by screw-fastening using fastening means 7 at the projections 57 on the reinforcing rib 55, so as to fasten the two transverse edges 404 of the module 400 relative to the reinforcing rib 55.

Once the desired number of photovoltaic modules 400 has thus be pre-mounted on each support device 3, the roof 500 is prepared for fastening the photovoltaic units 1 to the roof. To this end, when the photovoltaic units 1 are mounted in integrated manner, the rows of tiles covering the desired mounting location for the photovoltaic modules 400 are removed. Then the section member 5 of each photovoltaic unit 1 is fastened to the battens of the roof 500, by fastening the web 51 of the section member 5 to the battens 500 by means of screws. This screw-fastening may be performed in the vicinities of the ends 5A of the section member 5, by releasing the end plates 4 from the section member 5. The end plates 4 are then fastened to the section member 5 again, in such a manner as to close off the access to the volume V while allowing air to flow through the volume V. The web 51 of the section member 5 may also be fastened by screws to the battens 500 in intermediate zones of the web 51 between the ends 5A of the section member 5, by temporarily releasing one or more modules 400 from the section member 5.

In a variant, the pre-mounted photovoltaic units 1 can be mounted as superstructure on the roof 500, the section member 5 of each unit then, for example, being fastened to beams mounted above the tiles 501 of the roof 500.

In particularly advantageous manner, the step of pre-assembling the photovoltaic modules 400 with their support devices 3 in such manner as to form photovoltaic units 1 may be performed in the workshop, the photovoltaic units 1 then being transported, and then mounted on a structure for receiving the photovoltaic modules 400. Since the modules 400 are pre-mounted on the section members 5, the risk of the modules 400 being damaged while they are being transported and while they are being mounted is limited. In addition, the presence of the guide element 8 received in the reinforcing rib 55 makes it possible to channel all of the connection cables 408 of the modules 400 supported by a section member 5, thereby facilitating management of said cables while the photovoltaic units 1 are being mounted on a host structure. Pre-mounting the modules 400 on the section members 5 in the workshop makes it easy to install them on site, such installation not requiring skilled labor, and the cost of installing the modules 400 then being significantly reduced.

In the second embodiment shown in FIGS. 4 and 5, elements analogous to elements of the first embodiment bear identical references plus 100. The energy recovery unit 101 for recovering energy from solar radiation that is shown in FIG. 4 is a photovoltaic unit that, in a manner analogous to the first embodiment, comprises a plurality of photovoltaic modules 400, two of which are shown in FIG. 4. The unit 101 further comprises a support device 103 for supporting said modules 400 that comprises a section member 105 that is of elongate shape, and that is suitable for receiving photovoltaic modules 400, and a guide element 108 for guiding the connection cables 408 of modules 400 mounted on the section member 105. A longitudinal axis of the section member 105 is referenced X₁₀₅, which section member is analogous to the section member 5 of the first embodiment. The section member 105 has a web 151 and two side flanges 153, the web 151 being provided with a central and longitudinal reinforcing rib 155 that projects towards the inside of the section member 105, and that is suitable for supporting a middle portion of each module 400 mounted on the section member 103, via a pad 115 analogous to the pad 15 of the first embodiment, and that can be seen in section in FIG. 6. Each side flange 153 of the section member 105 is shaped, preferably by forming, in such manner as to define a groove 154 or 156 that is open towards the inside of the section member 105, the grooves 154 and 156 being arranged facing each other. As in the first embodiment, the groove 154 in the section member 105 is designed to have a depth a that is greater than the depth b of the groove 156, each groove 154 or 156 further having dimensions adapted to receive a longitudinal edge 402A or 402B of a module 400 equipped with a seal 406. Thus, each groove 154 or 156 is suitable for receiving a respective longitudinal edge 402A or 402B of a photovoltaic module 400, while the opposite longitudinal edge 402A or 402B is received in the other groove. In addition, by means of the relative depths of the grooves 154 and 156, it is possible, in the configuration in which one longitudinal edge 402A of a module 400 is engaged to the maximum extent into the groove 154, to insert or to extract the opposite longitudinal edge 402B of the module relative to the groove 156.

The second embodiment of the support device 103 differs from the above-described support device 3 in that the web 151 of the section member 105 is provided with rectangular cutouts 152. Said cutouts 152, that may be of various shapes, make it possible for light to pass, in particular when the photovoltaic unit 101 is integrated into a roof of the atrium roof or atrium window type. These cutouts are optional.

In a variant of the invention (not shown) additional cutouts, comparable to the cutouts 152, may be provided in the side flanges 153 or in the reinforcing rib 155. The additional cutouts may be of any shape adapted to their purpose.

The cutouts 152 and/or any additional cutouts make it possible for light to pass through and, in particular when the section member 105 is mounted offset relative to a wall of a building or in free-standing manner, for air for cooling the modules 400 to pass through, towards the volume V defined between the section member 105 and said modules, or from said volume.

The support device 103 also differs from the first embodiment of the support device 3 in that the fastening means 107 for fastening each module 400 relative to the section member 105, in a configuration in which the two opposite longitudinal edges 402A and 402B of the module are received respectively in the groove 154 and in the groove 156, comprise self-locking elements 172 and 173 that are suitable for being secured respectively to the flanges 153 and to the reinforcing member 155, at positions adjustable along the longitudinal axis X₁₀₅. Each self-locking element 172 or 173 is made up of two parts 172A & 172B, or 173A & 173B that are suitable for being clamped together by means of a screw 174 or 175, so that, in the configuration in which the two parts 172A & 172B, or 173A & 173B of a self-locking element 172 or 173 are clamped together around a corresponding portion of the flange 153 or of the reinforcing rib 155, the self-locking element 172 or 173 is held stationary relative to said portion. In a variant, the component parts of each self-locking element 172 or 173 may be clamped together by any suitable means other than a screw 174 or 175, e.g. by clamping by means of a spring, or by clamping by means of a cam.

The self-locking elements 172 and 173 are adapted to be held stationary on the section member 105 without it being necessary for said section member 105 to be perforated, thereby facilitating distribution of said locking elements 172 and 173 in the longitudinal direction of the section member 105 and guaranteeing the weatherproofing of the section member. The section member 105 is provided with a groove 105A into which a rib 172N on the part 172A is engaged. The section member 105 also defines a margin 105B, projecting towards the rib 155 from the flange 153, while the piece 172B is provided with a lip 172P that is suitable for coming into abutment against the surface of the margin 105B facing towards the web 151 of the section member 105. By tightening the screw 174, it is possible to hold the element 172 firmly stationary on the section member 105, by co-operating shapes. In the same way, the rib 155 is provided with two longitudinal grooves 155A and 155B into which two ribs 173N and 173P are engaged that are provided on respective ones of the parts 173A and 173B, so that tightening the screw 175 causes the self-locking element 173 to be held stationary on the rib 155 by co-operating shapes, without perforating the section member 105

In the example shown, three self-locking elements, namely two elements 172 and one element 173, are designed to be arranged between each pair of adjacent modules 400 mounted on the section member 105, in the vicinities of the transverse edges 404 of said modules. For each set of self-locking elements 172 and 173 arranged between a pair of adjacent modules 400, the fastening means 107 comprise two screws 171 suitable for co-operating with the parts 172A of the two self-locking elements 172 that are secured to the flanges 153, and a glazing bead 102 that covers, in touching manner, portions of the front faces 401 of the two adjacent modules 400, in the vicinities of the transverse edges 404 of the modules. The two screws 171 pass through the glazing bead 102 and each of them co-operates with the part 172A of the corresponding self-locking element 172. In a variant of the invention that is not shown, the fastening means 107 may comprise only self-locking elements 172 or only self-locking elements 173. The use of self-locking elements 172 and/or 173 having positions that are adjustable along the longitudinal axis X₁₀₅ makes it possible to fasten, relative to the section member 105, modules 400 that are of different lengths parallel to the axis X₁₀₅.

As appears from FIG. 5, unlike the guide element 8 of the first embodiment, the guide element 108 of the support device 103 is arranged in the air flow volume V defined between the web 151 of the section member 105 and the modules 400 mounted on the section member 105, in the vicinity of a flange 153 of the section member 105. Advantageously, the guide element 108 is made of a synthetic material and is adapted to co-operate by snap-fastening with the corresponding flange 153 of the section member 105.

In an aspect of the invention that is shown in FIG. 5 only, in order to make the drawings clearer, and when the optional cutouts 152 are not provided, a layer 165 of thermally-insulating and soundproofing material is placed on the section member 105, on its side 105C that is designed to face towards the roof to be equipped, i.e. towards the inside of a building on which the support device 103 is mounted. This insulating and soundproofing layer 165 is made of a synthetic material in foam form, e.g. polyurethane foam, and it fills both the inside volume of the central rib 155 and the sides of the flanges 153, on the outsides thereof. The layer of insulating and soundproofing material 165 also extends under the web 151 of the section member 105. This makes it possible to impart to the section member 105 a thermal insulation function in addition to its support function. A protective sheet 166 made of aluminum foil or of some other metal foil is pressed against the faces of the layer 165 that are not in contact with the section member 105.

In an aspect of the invention that is not shown, in order to make the drawings clearer, the geometrical shape of the layer 165 and of the sheet 166 is adapted to make it possible to stack the devices 103 prior to installing them on site, regardless of whether or not the modules 400 are in place.

FIG. 6 shows a variant of the photovoltaic unit 101, in which variant the heat that accumulates in the volume V is used advantageously for the purposes of heating the building equipped with the unit 101. In this variant, the support device 103 is provided with a mounting element 106 for mounting pipes 700 inside the volume V, a heat transfer fluid, e.g. water to which antifreeze is added, flowing through said pipes. The mounting element 106 is made of a synthetic material and is adapted to co-operate by snap-fastening with the section member 105. The heat recovery achieved by the heat transfer fluid that flows through the pipes 700 makes it possible to increase the energy efficiency of the unit 101, by converting the energy from solar radiation both into electrical energy and into thermal energy. In addition, it is possible, when the photovoltaic modules 400 mounted on the section member 105 are covered with snow, e.g. when the unit 101 is used in a mountainous zone, to heat the heat transfer fluid flowing through the pipes 700 in such a manner as to increase the temperature prevailing inside the volume V behind each module 400 and as to melt the layer of snow that isolates the photovoltaic cells 410 of each module 400 from the solar radiation. In such a situation, the heat transfer fluid that flows through the pipes 700 is advantageously a mixture of water and of antifreeze.

In the third embodiment shown in FIGS. 7 and 8, elements that are analogous to elements of the first embodiment bear identical references plus 200. The energy recovery unit 201 for recovering energy from solar radiation shown in FIGS. 7 and 8 comprises a plurality of photovoltaic modules 400 and a support device 203 for supporting said modules 400. The support device 203 comprises a section member 205 that is of elongate shape, that is analogous to the above-described section members 5 and 105, and that comprises a web 251 and two side flanges 253. Each side flange 253 is shaped, preferably by forming, in such a manner as to define two grooves 254 and 256 that are open towards the inside of the section member 205 and arranged facing each other, so that each groove 254 or 256 is suitable for receiving a longitudinal edge 402A or 402B of a photovoltaic module 400 while the opposite longitudinal edge 402B or 402A of the module is received in the other groove. In the configuration in which a photovoltaic module 400 is mounted on the section member 205, an air-flow volume V is defined between the module 400 and the web 251 that makes it possible to maintain the modules 400 at a temperature that is satisfactory for them to operate. The groove 254 is designed to have a depth a that is greater than the depth b of the groove 256. Thus, in the configuration in which one longitudinal edge 402A of a module 400 is engaged to the maximum extent into the groove 254, it is possible to insert or to extract the opposite longitudinal edge 402B of the module relative to the groove 256.

The support device 203 differs from the above-described support devices in that it further comprises a locking rod 209 for locking the modules 400 in the configuration in which they are mounted on the section member 205. The locking rod 209, that is of elongate shape, is designed to be inserted into the groove 254 in such a manner as to limit the extent to which the longitudinal edges 402A of the modules 400 are engaged in said groove 254. The rod 209, that may be rigid or semi-rigid, thus guarantees that each module 400 mounted on the section member 205 is held in a configuration in which the two opposite longitudinal edges 402A and 402B of the module 400 are received respectively in the groove 254 and in the groove 256.

The rod 209 also performs a theft-prevention function. To this end, the rod 209 is equipped, at one of its ends 209A, with a contactor 291 designed to co-operate with a corresponding contactor 206 that is secured to the section member 205. When the contactor 291 is moved away from the contactor 206, an electrical circuit that is initially closed by the link established between the contactors 291 and 206 becomes open, thereby triggering an audible or visible alarm system. It is thus possible to identify a fraudulent act committed on the unit 201 for the purpose of releasing one or more photovoltaic modules 400 from the section member 205. In addition, the rod 209 is designed to have a length shorter than the length of the section member 205, so that the second end 209B of the rod 209 can be reached only by means of a tool 600 that is specially designed for extracting the rod 209 from the groove 254. By way of example, the tool 600 may have a threaded end suitable for co-operating with a corresponding threaded end-piece 293 of the end 209B of the rod 209.

As appears from the three above-described examples, a support device 3, 103, 203 of the invention, comprising a section member 5, 105, 205 of the cladding type, makes it possible to limit the host structure to be provided for mounting the photovoltaic modules 400, insofar as the section member 5, 105, 205 itself constitutes a structural part. Since the modules 400 that have each of their longitudinal edges 402A and 402B equipped with a seal 406 are mounted in weatherproof manner in the grooves in the corresponding section member 5, 105, 205, the weatherproofing of the roof 500 as equipped with the photovoltaic modules 400 is guaranteed, even when the section member has cutouts as in the second embodiment. The dimensions of each section member 5, 105, 205 may advantageously be adapted to the type of module 400 to be installed and to the number of said modules. In particular, it is possible to cut each section member 5, 105, 205 to a length adapted for pre-mounting a desired number of modules 400. The presence of the central reinforcing rib 55, 155 of the section member 5, 105, 205 guarantees that satisfactory strength is imparted to the roof 500 that includes the photovoltaic modules 400, so that said roof is suitable for withstanding a considerable weight without any risk of it breaking at the modules 400. In particular, the central rib 55, 155, that constitutes a support for a middle portion of each module 400 mounted on the section member 5, 105, 205 makes it possible to design the modules 400 of a photovoltaic unit 1, 101, 201 with a lighter-weight structure, thereby limiting the cost of said modules and facilitating handling thereof. In addition, by means of a support device 3, 103, 203 of the invention, the dimensions of the ventilation volume V making it possible to maintain the modules 400 at an optimum operating temperature are kept well under control, by appropriate cutting out and folding of the blank from which each section member 5, 105, 205 is made.

FIG. 9 shows an air removal system 900 suitable for being associated with a set of energy recovery units 1, 101, 201 as shown in any one of FIG. 1, 4, 6, or 7. The system 900 comprises ducts 901, 902, 903, 904 for removing hot air contained in the internal volume V of each unit 1, 101, 201, each of which ducts is equipped with means for extracting said hot air. In particular, the duct 901 is connected to a Venturi-effect extraction vent 905, while the duct 902 is equipped with a fan 906 suitable for forcing the flow of hot air towards the ducts 903 or 904 that channel the hot air respectively towards the outside and towards a heating system for heating the building that is equipped with the set of energy recovery units 1, 101, 201, 301.

In the fourth and fifth embodiments of the invention that are shown in FIGS. 10 and 11, elements analogous to elements of the second embodiment bear like references. The description below describes mainly what distinguishes these two embodiments from the embodiment shown in FIG. 6.

In the embodiment shown in FIG. 10, a photovoltaic module 400 is inserted via one of its edges 402B into a groove 156 in a section member 105. A main plane of the module 400 that is equidistant from its front and back faces 401 and 403 is referenced P₄₀₀. The thickness of the module 400 as measured perpendicularly to the plane P₄₀₀ between the faces 401 and 403 is referenced e₄₀₀.

A resilient element 191 is fastened over the edge of the groove 156 by shape co-operation with a rib 157 provided on the section member 105. The resilient element 191 is made of spring steel and it exerts a resilient force E₁ on the edge 402B, on the side thereof that constitutes the face 401 of the module 400, which force presses the face 403 against a surface 156B of the section member 105 that defines the groove 156 opposite from the rib 157.

The resilient force E₁ thus prevents the module 400 from vibrating, in particular when it is subjected to wind, and makes it possible for modules 400 of various thicknesses e₄₀₀ to be received in the groove 156. A second resilient element of the same type as the element 191 is mounted on the section member 105 in the vicinity of its other rib, and has the same function as the element 191.

In addition, the section member 105 is provided with an end hook 158 that extends over its entire length and that defines a volume V₁₅₈ for receiving a tongue provided on that side of each section member that is opposite from its hook 158. In FIG. 10, a second section member 105′ that is identical to the section member 105 is shown with its tongue 159′ engaged in the internal volume of the hook 158.

The hook 158 and the tongue 159′ of the section members 105 and 105′ thus make it possible for the two adjacent section members to be made to run on continuously from each other as shown in FIG. 10 by means of co-operating shapes. Once the tongue 159′ of the section member 105′ is engaged in the hook 158, it is possible to deform the hook 158 locally, in particular by pinching it, thereby constituting “stapling” in order to anchor the tongue 159′ firmly in the hook 158.

In a variant of the invention that is not shown, the fastening between the resilient element 191 and the section member 105 can be achieved by means of a projecting portion, of the rib type, provided on the element 191 and engaged in a corresponding groove provided in the face of the section member 105 that defines the groove 156 opposite from the surface 156B.

In the embodiment shown in FIG. 11, instead of the element 191, an elastomer seal 192 is used that exerts a resilient force E₁ on the edge 402B of a module that is engaged in the groove 156, which force is perpendicular to the above-defined midplane P₄₀₀ of the module 400. This elastomer seal 192 constitutes an alternative to the spring element 191 of the embodiment shown in FIG. 10, and it performs substantially the same function. In this embodiment, it is also possible to make two adjacent profiles 105 and 105′ run on continuously from each other, as explained with reference to the embodiment shown in FIG. 11.

In the embodiment shown in FIG. 12, elements that are analogous to elements of the first embodiment bear like references. Only what distinguishes this embodiment from the first embodiment is described below. In this embodiment, in addition to or instead of the spring 9 of the first embodiment, a locking member 193 is engaged in the groove 54 after the modules 400 have been put in place in the configuration of FIG. 1. To this end, the locking member 193 is slid into the gap I between the transverse edges 404 of two modules 400 disposed in the same section member 5, which gap I can be seen in FIG. 1.

The locking member 193 is provided with a strip 194 enabling it to be manipulated with the fingers so as to slide it parallel to the axis X₅, by engaging it in the groove 54 in the section member 5. The member 193, that is made of spring steel, is also provided with a tab 195 that is suitable for exerting a resilient reaction force E₂ on the edge 402A of a module 400 engaged in the groove 54, which force is directed towards the opposite groove in the section member 5, if the module 400 is moved towards the end wall 54C of the groove 54. In other words, the locking member 193 prevents the edge 402A of a module 400 from being pushed into the groove 54 to such an extent that its opposite edge 402B could be removed from the opposite groove, of the same type as the groove 56 in the section member of the first embodiment.

As appears from the above-described embodiments, a support device 3, 103 or 203 of the invention for supporting energy recovery modules for recovering energy from solar radiation makes it easy and inexpensive to mount energy recovery modules on a structure, such as a roof or a façade of a building. In the mounted configuration in which the devices 3, 103 or 203 are mounted, as shown in FIG. 9, the respective longitudinal axes of the section members 5, 105, and 205 are perpendicular to the ridge of the roof, so that the volumes V defined by said section members are elongate in the same direction as the slope of the roof, thereby facilitating the flow of air towards the vent 905. This is highly advantageous compared with the situation in which horizontal crosspieces are used for supporting solar panels and in which said crosspieces hinder the flow of air.

A support device 3, 103, or 203 of the invention makes it possible for energy recovery modules to be pre-mounted, in such a manner as to form energy recovery units 1, 101, 201 that are stronger than the modules taken individually. This feature can be brought together with the fact that a single section member 5, 105, or 205 supports the two opposite edges of the same module 400 by means of two adapted grooves 54, 56 or the like, thereby making it possible safely to transport and to protect a set of modules mounted on such a section member.

The risk of the energy recovery modules being damaged during transport and installation is therefore limited. In addition, an energy recovery unit 1, 101, 201 of the invention, comprising a support device 3, 103, 203 of the invention and energy recovery modules, is suitable for being fastened easily to a host structure, such as a roof, in a manner such as to be integrated into the structure or in a manner such as to be mounted as superstructure thereon, by fastening with screws or by any other suitable technique for fastening the section members 5, 105, 205 of the energy recovery unit 1, 101, 201 relative to the host structure. The specific profile of the grooves or of the section members 5, 105, 205 of a support device of the invention makes it possible to install the energy recovery modules reliably and reversibly on the section member(s). This reversible installation of the energy recovery modules on the section member(s) 5, 105, or 205 makes it possible for each module to be removed individually from the section member so that each module can be replaced individually in the event of failure.

The invention is not limited to the examples described and shown. In particular, in each of the above-described embodiments, the photovoltaic solar modules 400 can be replaced with thermal solar modules. A combination of thermal solar modules and of photovoltaic solar modules is also possible, by juxtaposing modules of different types on the section members of the support devices 3, 103, 203 of the invention. In addition, an energy recovery unit 1, 101, 201, 301 of the invention, comprising a support device 3, 103, 203 of the invention and energy recovery modules, may be mounted on any host structure, in particular on a roof as described above, on a wall belonging to a façade, or indeed on a free-standing structure.

In addition, cutouts analogous to the cutouts 152 provided in the web of the section member 105 of the second embodiment of the support device 103 may be provided in the first and third embodiments of the section members 5 and 205. Said cutouts may also be of shape different from the shape shown in FIG. 4, and in particular of circular shape.

The section member 5, 105, 205, of the cladding type, that is part of the support device 3, 103, or 203 in the first three embodiments may also be provided with a plurality of longitudinal reinforcing ribs 55, 155, juxtaposed in the transverse direction of the section member, so as to increase the strength of the energy recovery unit 1, 101, 201 formed by mounting energy recovery modules on the section member 5, 105, 205. A section member of the cladding type having one or more longitudinal reinforcing ribs may also be used for mounting energy recovery modules for recovering energy from solar radiation independently of the presence of grooves for receiving opposite edges of each module, each rib being suitable for receiving, in abutment, a back face of each module mounted on the section member. The advantages in terms of strength of the roof that incorporates the modules and of lightening in weight of the structure of each module are then preserved.

The section members 5 and 205 of the cladding type may also be covered with foam, in such a manner as to improve the thermal insulation, and optionally the soundproofing, of the roof that incorporates the energy recovery modules, as shown in FIG. 5 for the section member 105.

Each energy recovery module 400 mounted relative to a section member 5, 105, 205 of a support device of the invention in a configuration in which the two opposite longitudinal edges 402A and 402B of the module 400 are received in respective grooves, may be held in that configuration, in the first and fourth embodiments, by means of a locking rod analogous to the rod 209 in the third embodiment. In addition, regardless of the embodiment, the means for fastening energy recovery modules on a section member of a support device of the invention may comprise self-locking elements analogous to the elements 172 and/or 173 of the second embodiment. In particular, the fastening means 107 of the second embodiment may be used in the first embodiment, instead of the fastening means 7, it then being possible to omit the projections 57 on the section member 5.

Installing heat transfer fluid pipes in the air flow volume V may be transposed to the first, third, and fourth embodiments, the volume V being defined either between the web of the section member 5, 105, 205 of the cladding type of a support device 3, 103, 203 of the invention and a module mounted on said section member. The guide elements 8, 108 for guiding connection cables may also be used for guiding pipes. In addition, in the mounted configuration in which the modules are mounted on the side flanges of the section member, pipes for conveying a heat transfer fluid in the air flow volume V defined between the web of a section member of the cladding type and photovoltaic modules may be installed independently of the presence of grooves for receiving opposite edges of each module. The advantages in terms of increasing the efficiency of the energy recovery unit for recovering energy from solar radiation and of clearing the photovoltaic cells of any layer of snow are then preserved.

Except when cutouts are provided such as the optional cutouts 152 shown in FIG. 4, the web 51, 151, or 251 of a section member 5, 105, 205 provides weatherproofing between the outside and the roof on which it is mounted, in particular against runoff water.

The technical characteristics of the various embodiments described and considered above may be combined with one another, within the ambit of the invention defined by the accompanying claims.

1-19. (canceled)

20. A support device for supporting at least one energy recovery module for recovering energy from solar radiation, the support device being of the type provided with a first groove and with a second groove that are arranged in stationary manner facing each other, each groove being suitable for receiving one edge of the module while an opposite edge of the module is received in the other groove, said opposite edge being suitable, in the configuration in which one edge of the module is engaged to the maximum extent in one of the first and second grooves, for being extracted from the other groove, the device being provided with holding means for holding the module in a configuration in which the two opposite edges of the module are received respectively in the first groove and in the second groove, said support device comprising a section member that is provided with the first and second grooves.

21. A support device according to claim 20, wherein the holding means comprise means for fastening the module relative to the support device.

22. A support device according to claim 20, wherein the first groove and the second groove have different depths, the holding means comprising a locking rod arranged in the groove of greater depth.

23. A support device according to claim 3, wherein the locking rod is suitable for actuating an alarm system in the event that the locking rod is extracted from the groove in which it is arranged.

24. A support device according to claim 20, wherein the section member is made from a metal blank that is shaped by continuous forming.

25. A support device according to claim 20, wherein a layer of insulating material is placed on a side of the section member that is designed to face towards the inside of a building equipped with the support device.

26. A support device according to claim 20, wherein the section member is provided with cutouts making it possible for light and/or cooling air to pass through to or from a volume defined between the section member and a module mounted on said section member.

27. A device according to claim 20, wherein it is further provided with a member suitable for exerting a resilient force on an edge of a module engaged in the groove, which force is perpendicular to a main plane of the module.

28. A device according to claim 20, wherein it is further provided with a member suitable for exerting a resilient force on an edge of a module that is engaged in one groove, which force is directed towards the other groove in the section member.

29. A device according to claim 20, wherein the section member is provided with means for making it run on continuously from an adjacent section member.

30. A support device according to claim 20, wherein the action member is provided with at least one reinforcing rib, the or each reinforcing rib being suitable for supporting one face of the module when said module is in the configuration in which the two opposite edges of the module are received respectively in the first groove and in the second groove.

31. A support device according to claim 20, wherein the first and second grooves are arranged in the section member(s) in such a manner that, when the module is in the configuration in which the two opposite edges of the module are received respectively in the first groove and in the second groove, an air flow volume is defined between a web of the section member and the module.

32. A support device according to claim 31, wherein it is further provided with at least one pipe through which a heat transfer fluid can flow, said pipe being arranged in said air flow volume.

33. A support device according to claim 20, wherein the section member comprises a web and two side flanges, each side flange defining one of the first and second grooves.

34. A support device according to claim 20, wherein it is further provided with fastening means for fastening the module relative to the or to each section member, said fastening means including self-locking elements suitable for being fastened to the or to each section member in such a manner as to be adjustable in a longitudinal direction of the section member.

35. A device according to claim 34, wherein the self-locking elements are made up of two parts suitable for being clamped around a portion of the section member.

36. An energy recovery unit for recovering energy from solar radiation, the unit being of the type comprising at least one energy recovery module for recovering energy from solar radiation, said energy recovery unit further comprising a support device according to claim 20, the or each module being mounted on the support device.

37. An air removal system for removing air from at least one energy recovery unit for recovering energy from solar radiation according to claim 36, said system comprising ducts for removing hot air contained in a volume, defined between a web of the section member and the module of the unit, towards the outside or towards means for using said hot air.

38. A method of mounting at least one energy recovery module for recovering energy from solar radiation on a structure, such as a roof or a façade of a building or indeed a free-standing structure, by means of a support device according to claim 20, said method being wherein it comprises steps consisting in:
pre-mounting the or each module on the section member of the support device by performing at least the following operations:
engaging one edge of the module to the maximum extent in one of the first and second grooves in the section member;
pivoting the module in such a manner as to bring the opposite edge of the module to face the other of the first and second grooves in the section member;
engaging the opposite edge of the module in the other groove in the section member, by moving the module in translation;
holding the module stationary relative to the support device in a position in which the two opposite edges of the module are received respectively in the first groove and in the second groove; and
fastening the support device to the structure.
